(19) United States
(12) Patent Application Publication
(10) Pub. No.: US 2008/0063456 A1
(43) Pub. Date: Mar. 13, 2008

(54) Deployable Keyboard Device Including Displaceable Keybutton Positions for Portable Miniature Electronic Devices

(75) Inventor: Roy J. Lahr, Los Angeles, CA (US)

Correspondence Address: KENYON & KENYON LLP, ONE BROADWAY, NEW YORK, NY, 10004, US

(73) Assignee: Rast Associates, Long Beach, CA (US)

(21) Appl. No.: 10/591,143

(22) PCT Filed: Feb. 28, 2005
(86) PCT No.: PCT/US05/06543

§ 371 Date: Aug. 9, 2007

Related U.S. Application Data
(60) Provisional application No. 60/548,644, filed on Feb. 26, 2004.

(51) Int. Cl. B41J 5/12

(52) U.S. Cl. 400/491

(57) ABSTRACT

In a miniature keyboard, keybuttons may shift their relative positions from a relatively smaller array when stored to deployment which results in a relatively larger array for active keyboard use. An application for this positional adjustment is the use of the keyboard for inputting data with fingertips when used with portable miniature electronic devices, e.g., small cellphones.

### CROSS-REFERENCE TO RELATED APPLICATIONS

The present application claims the benefit of U.S. Provisional Application No. 60/548,644, filed on Feb. 26, 2004, which is expressly incorporated herein in its entirety by reference thereto. The present application is also related to U.S. Provisional Application No. 60/497,241, filed on Aug. 23, 2003, and U.S. patent application Ser. No. 10/925,237, filed on Aug. 23, 2004, each of which is also expressly incorporated herein in its entirety by reference thereto.

### FIELD OF THE INVENTION

The present invention relates to a keyboard device. More particularly, the present invention relates to a system arranged to permit keyboard expansion from a smaller storage shape to a substantially larger “ready for use,” “ready for typing” or “ready for data entry” shape to facilitate data input for control of an, e.g., miniature, electronic device. In addition, the present invention relates to a keyboard which may be adjusted to vary the size of the keyboard, the size of the keycaps of the keyboard and the spacing between the keycaps.

### BACKGROUND INFORMATION

Reference is made to: U.S. Pat. No. 5,008,864 to Yoshitake, U.S. Pat. No. 5,037,163 to Hatcher, U.S. Pat. No. 5,054,051 to Hoff, U.S. Pat. No. 5,224,076 to Thorp, U.S. Pat. No. 5,251,189 to Thorp, U.S. Pat. No. 5,274,613 to Seager, U.S. Pat. No. 5,901,934 to Wilson, U.S. Pat. No. 6,155,841 to Spanyar, U.S. Pat. No. 6,271,835 to Hoeksma, U.S. Pat. No. 6,454,369 to Cooper et al., U.S. Pat. No. 6,467,860 to Remmers and U.S. Pat. No. 6,487,421 to Hess et al.

Advances in miniaturization technology may permit wristwatch-sized cellphones. These miniature cellphones may be detachably worn on the wrist, serving as timepieces between cellphone calls, or alternately carried in the pocket as separate instruments. They may even be worn on the surface of clothing, pendant style. As a generic label for these ultra small “postage stamp size” communication devices, they will be termed “micro cellphones” in the following text.

When the entire micro cellphone is the size of a wrist watch, or slightly smaller (postage stamp size), the design of the data input keyboard is challenging. A very small keyboard may be operated by the tip of a stylus, but this is not a convenient operation for the user. In this regard, reference is made to U.S. Pat. No. 6,487,421 to Hess et al., in which a specialized stylus is believed to be described for data input.

Data processing and network link requirements make voice recognition operation in such miniature cellphones largely impractical for the near term, so that some type of “keyboard” data input is required.

Fingertip key button operation is considered the most convenient data entry system. Thus, for user ergonomics and ease of use, providing keycaps of a size that is more visible and that makes fingertip depression of the desired keycap easy is a perceived benefit. It may also be beneficial to space the keycaps sufficiently so that accidental operation of an adjacent keybutton is infrequent.

A response to the need for a keyboard for use with a very small cellphone is described in U.S. Pat. No. 6,155,841 to Spanyar in which a film-layer based keyboard is described for sewn attachment to a nearby jacket sleeve.

U.S. Pat. No. 6,271,835 to Hoeksma is believed to describe a touch screen in which the displayed keybutton label and size is controlled by internal device electronics. Thus, the user may be provided with an optimized touch display customized on the forecast of “next keystroke needed.”

There is believed to be a need to provide physical separation of cellphone microphone and earphone locations which approximates the several inch separation between mouth and ear of the user. Certain patents are believed to have proposed solutions which unfold a wrist band to provide a separation between earpiece and microphone. Among these patents are believed to be U.S. Pat. No. 5,008,964 to Yoshitake, U.S. Pat. No. 5,274,613 to Seager and U.S. Pat. No. 5,251,189 to Thorp. Alternately, a RF wireless link to a separate headphone unit may be provided, such as is believed to be described in U.S. Pat. No. 5,045,051 to Hoff.

For general purpose use of the cellphone, continually wearing a separate, linked headphone may not always be convenient. It may also be inconvenient if the user must wait to answer or initiate a cellphone call until the separate headphone unit is withdrawn from a storage location, power turned on, and then placed on the side of the head. As described below, deployment of the keyboard in an example embodiment of the present invention from storage compaction may provide the desired separation of microphone and earphone locations.

There exists at least two types, or instances, of constraints on keycap size when designing a micro cellphone keyboard. In the first instance, if the keycaps remain the same size between storage and use, then it may be favorable to make the size of the keycap as large as possible within the storage space available and then to create space between these fixed size keycaps as the device transitions between storage and use conditions. This may allow the user to easily differentiate between keycaps and may reduce mistaken keybutton depressions, since a fingertip may be about the same size as the top surface of the keycap. It may also permit a larger keycap “real estate” on which to put legends.

Letters that may be translated into dialing numbers are used when it is desirable for a person to quickly remember a number from a letter and number sequence than with a number sequence alone.

Thus, one may see plumbing trucks with signs that read, for example, “Call 1-800-TRYHARRY” since the owner feels that this may be a more memorable sequence when you want a plumber than “Call1-800-879-4277” would be. A consequence of this is that one may need to be able to easily read the alphabetic legends near each number key on the micro cellphone in order to dial the number correctly.

Thus, keycaps may need to bear dual legends, such as a number plus groups of letters (1 and “ABC”; 2 and “DEF”; 3 and “GHI”; etc.). It may thus be favorable to make the letter groups written on the keycap tops, along with the numbers, as large as possible so that the user does not need a magnifying glass to visually select the desired character or number on a keycap.

It is also possible to “semi-stack” the keycap top plates during storage, much in the manner of roof tiles. The amount of tiled stacking available may be limited by the keybutton's switch actuator size compared to the overall keybutton top size. Note that this tiling arrangement may also add some extra height to the keyboard when in a storage position, and for really small micro cellphones, this may be an impractical tradeoff.

The second instance of micro cellphone keyboard design may utilize keybutton tops that change actual size between storage and use positions. Various arrangements of accomplishing keycap size change are described in U.S. Pat. No. 6,739,774 to Lahr, which is expressly incorporated herein in its entirety by reference thereto, and those arrangements of keycap expansion may be used herein. Note that if the keybutton physically expands, the presented legend on the keytop may also be caused to expand during the transition between storage size and final use size of the micro cellphone's keycap.

While this discussion has its principal focus on number dialing keyboards for micro cellphones, the same deployable keyboard technology may be used for somewhat larger keyboards, as on Personal Data Assistant devices (PDA') or on “Smart Phones,” which may have larger alphanumeric data entry keyboards.

Note that while single direction expansion (X-axis only), e.g., essentially in a single plane, may be used to provide more active keyboard area when the keyboard is deployed for use, it may be more favorable to employ both X- and Y-direction planar expansion.

While expanding a “surface mount” keyboard may be practical, for very tiny keyboard designs, it may be favorable to consider “drawer” type deployment for these very small devices. One or more “drawers” may be used to house the keyboard in its storage mode. When the drawers are extended, the keyboard is brought forth, and the keyboard may expand in at least the X-(width) dimension. Alternately, the deployed keyboard may expand in both the X-(width) and Y-(length) dimensions.

Certain aspects of the use of a pull-out drawer associated with wrist-carried communication devices or computer equipment are believed to be described in a number of U.S. patents.

For example, U.S. Pat. No. 5,224,076 to Thorp is believed to show a small telescoping “drawer like” section telescoping out from a wrist carried radio telephone (an earlier terminology), but the device's keyboard is not carried on the extending drawer sections. Rather, the extending drawer sections provide a physical distance between the microphone on the end of the drawer and the earphone unit mounted on the other side of the radio telephone, and the keyboard is mounted just beneath the display area and does not move or change size.

U.S. Pat. No. 5,037,163 to Hatcher is believed to describe a single drawer which slides out, as from under an existing computer table. A completely separate keyboard (standard layout) is placed upon this surface. Thus, when not in use, the drawer slides back under the computer table surface, but may be slid out when the computer was in use, so as to save computer desk top space. The action of the sliding parts is discussed therein.

U.S. Pat. No. 5,901,934 to Wilson is believed to describe a similar sliding “pull out” drawer, mounted under a computer table surface, but adds structure to the drawer that retracts and raises, as for instance, when the drawer is pulled out. A section of the drawer may remain flat to serve as a base for a mouse pad. The moving segment of the drawer may be used as a portion of the computer housing (or casing), if desired.

U.S. Pat. No. 6,454,369 to Cooper et al. is believed to describe a pullout drawer for mounting under a computer table. Cooper et al. add a front edge palm rest area near the zone where a keyboard will be placed, and facilitates the placement and movement of a cable (e.g., the usual keyboard to computer cable and presumably the mouse to computer cable as well).

U.S. Pat. No. 6,467,860 to Remmers is believed to describe a pullout drawer. But instead of a flat surface for mounting a keyboard (or mouse), the system houses a wire basket. The basket may be used for mounting other things, or, e.g., for storing or filing materials. The action of the sliding parts is discussed, with adaptations particularized for use with a wire basket “tray.”

While it may be common to provide a slide out drawer for utility uses, as just below a computer table surface, micro cellphone pull out drawers hereof may utilize multiple extension drawers, where, for example, for a two drawer configuration, each “drawer” provides one half of desired keyboard keys. The whole keyboard may be presented only when both keyboard drawers are extended, one below the other.

In the case of the micro cellphone, the bottom of the main electronic chassis becomes the “computer table” beneath which telescoping slides are mounted, and the sliding thus takes place beneath the electronic chassis of the micro cellphone, e.g., one drawer beneath the other.

All keybuttons may be incorporated on the individual “drawers.” “Legend space” may be provided adjacent to the keybutton mounting area for additional information labels referring to an individual keybutton.

In addition, in the last four patents discussed above, the drawer trays are provided for the latter placement of objects, such as complete keyboards or computer mice.

And, while some of these drawer device patents may have presented facilitating cable placement for keyboard-to-desktop computer or mouse-to-computer wires, according to an example embodiment of the present invention, wiring may be completely integral to the drawer assembly and may be arranged to never be handled by the user. Herein, flexible polyamide strips with etched copper circuitry may be fixedly mounted between keybutton switch area and a logic board of an associated micro cellphone. The flexible polyamide strips may fold and/or loop and be arranged to allow slide-in or slide-out of the drawers without breaking the circuit connection between the keybutton switches and the micro cellphone logic board.

As techniques for miniaturizing electronic devices allow construction of ever smaller equipment, there is still believed to be a need for providing input data to control such tiny equipment. For example, it may be possible to construct a cell phone which can be carried on a wrist band or worn much as a pendant on clothing. However, since human fingers remain unchanged in size, it may become difficult to create input data by pressing buttons on such small cell phones. It may be possible to use a stylus to operate a very tiny keyboard so as to provide data or control input, but for a small cellphone whose overall size is that of a wrist watch or pendant, the user may have to operate the keyboard with a very short stylus, and such delicate hand operations may not be convenient. Voice recognition is another option, but this may require a complex algorithmic logic processing of voiced speech, not believed to possible with “on board” electronic logic in such small devices. Also, the recognition success of such an algorithmic voice control system in the presence of background noise tends to be low, and thus may be frustrating for the user, or requiring over-frequent “touchup” of the recognized input commands. Cellphone linking bandwidth is not yet high enough so as to be able to place the voice recognition computing circuitry at a more central location and share it between many cellphone users. Another difficulty with voice recognition capability in such small cellphones is providing consistent microphone placement with regard to the user's mouth. Without a stable input location for a microphone so as to have a consistent location relative to the mouth, the training cycles needed to recognize voice commands may not be sufficient so that the recognition accuracy may suffer significantly. In effect, the cellphone's “trained accuracy” may become little better than a “general purpose, any user” type voice recognition system, and the recognition accuracy may not be sufficient to provide frustration-free data input to the cellphone. With this type of voice recognition circuitry, it may be usual to provide a “check out” operation mode in which the system will “say back” through the user's headphone what it understands to be the voiced data input, as in the following script:

“Did you say ‘Dial one eight one eight four three seven five nine two one?’”

“Say ‘yes’ to make the call, or ‘no’ to redial (revoice) the number.”

Alternately, the system may accept the name of the person or company to be dialed, assuming there is enough cellphone linking bandwidth and sufficient available storage for such a task.

An illustration of a miniaturized, wrist-mounted communication device was presented in the comic strip “Dick Tracy” by its creator, Chester Gould in 1964. Gould was a crime-fighting tool innovator since the Dick Tracy comic strip started in 1931, and a U.S. Postal Service stamp shows the “two way wrist communicator” in use. It is thus reasonable that a number of arrangements that might help to actualize such a device have been proposed. Several of these are mentioned below:

U.S. Pat. No. 6,212,414 to Almech et al. is believed to describe a wrist mounted radiotelephone in which some of the circuitry is distributed within the body of the wrist strap.

U.S. Pat. No. 6,208,876 to Raussi et al. is believed to describe using a remote keypad as a data entry device to control a miniaturized device, such as a wrist mounted micro cellphone. The use of the remote keypad may allow sufficient room for electronic circuitry which may “lock” the miniature device so that unauthorized use may be prevented.

U.S. Pat. No. 6,192,253 to Charlier et al. is believed to describe a wrist mounted radiotelephone, in which portions of the micro cellphone body and wrist strap mounting cooperate to form a suitable configuration to allow using the wrist mounted device while it is still mounted on the wrist strap.

U.S. Pat. No. 6,158,884 to Lebby et al. is believed to describe combining wrist strap electronics with a wrist mounted device itself.

U.S. Pat. No. 6,151,208 to Bartlett is believed to describe changing the location of a portable computing device from the wrist to the back of the hand, close to the notch between the thumb and forefinger, perhaps being mounted using a glove.

U.S. Pat. No. 6,134,428 to Nakazawa is believed to describe a loop antenna in a wrist strap in an attempt to increase the reception sensitivity of a wrist mounted electronic device, and to help reject electronic noise interference.

U.S. Pat. No. 6,097,374 to Howard is believed to describe an “air typing” keyboard alternative for a wrist mounted device in which finger motion intercepts optical sensor paths that are located below the palm of the user. In addition, hand motion accelerometers mounted in the wrist device decode “gesturing” by the user into data streams to control the electronic device.

U.S. Pat. No. 6,091,965 to Varoba, et al. is believed to describe an attempt to improve the acoustic performance of the wrist cell phone by controlling the amplifier gain which operates the microphone and earphone. An ergonomic keypad to be associated with the wrist or pendant electronic device is also believed to be described, but there is not believed to be a description of a keypad which changes size between storage and use.

U.S. Pat. No. 6,081,107 to Batio is believed to describe a center folding keyboard for use with a portable computer. It is quite large as it attempts to provide full typing capability, and is thus not particularly appropriate for use with a wrist or pendant micro cell phone type device.

U.S. Pat. No. 6,044,153 to Kasche is believed to describe a micro electronic wrist mounted unit which extends from the back of the band upward around the forearm of the user. It is possible that some articulation of the device, as by a flexible glove mounting, may be necessary to avoid restraining wrist motions of the user. It is intended that the device remain on the arm and that the user positions the device against the side of the face so that the microphone is close to the user's mouth and the earphone is proximate to the user's ear. This may result in the need for locating the user's arm across the face during the speaking phase of use, and this arm position may not be favorable for many users.

Removal from a wrist mount or wearing the electronic device as a pendant may allow holding the electronic device between the ear and mouth with the forearm extended upward from the elbow and the hand grasping the electronic device. This is a more customary hand-arm position while making phone calls.

U.S. Pat. No. 6,025,217 to Kravitz is believed to describe replacing the twelve-key keypad of an electronic device with a single control button. The user communicates the desired number to be dialed to the service provider, as by speaking the number. After voice recognition and after comparison with stored information from the service provider, the number would be dialed.

There is believed to be no descriptions of how to efficiently accomplish the required voice recognition task, along with the data lookup task. It is assumed that the service provider would provide suitable audible feedback to the user so as to ensure that only desired numbers were dialed.

U.S. Pat. No. 6,035,035 to Firooz is believed to describe a wrist mounted telephone device in which the microphone is placed at one end, and a extendible side arm holds the earpiece at a distance, as up the wrist towards the back of the hand so as to gain distance between the microphone and earphone, as to improve acoustic performance.

The mounting of the earphone and microphone may require an “across the face” positioning of the user's arm, which may not be comfortable for many users. Persons with arthritic or otherwise compromised joint function may not be able to maintain this “across the face” arm positioning for an extended phone call.

U.S. Pat. No. 5,987,310 to Gray is believed to describe using a cellular phone mounted as a right hand glove worn ensemble. The microphone is positioned at the end of the little finger, and the earphone at the end of the thumb. In use, the fingers would be positioned with the thumb upraised and the little finger extended. The palm of the right hand is then positioned against the user's cheek so that the extended little finger is near the mouth.

While providing an acoustically efficient device, the requirement to wear a glove for a mounting of cellphone parts may not appeal to some users. It is believed to be unlikely that users would be willing to carry the special glove separately and slip it on before answering or using the cellphone device.

U.S. Pat. No. 5,974,000 to Pfeil is believed to describe having the control and dialing buttons on a wrist mounted electronic device in which the buttons are mounted around the periphery of the watch, as in a circle around the display edge. The rim-mounted buttons may be pressed singly or in combination, to address previously stored information, and create either information phrases or act as dialing instructions.

U.S. Pat. No. 5,949,643 to Batio is believed to describe a folding keyboard for storage compactness. Each half has its own keys and space bar. The incorporated display portions may be articulated into convenient positions for the user. The device is not appropriate in size for use with a wrist or pendant cell phone, but may be used as an alternative programming device for entering data into a memory storage for later retrieval.

U.S. Pat. No. 5,929,771 is believed to utilize an external data handling system, such as a small laptop computer which may use an infrared link data link to a wrist mounted information device. Both numeric and textual information may be exchanged between the external unit and the wrist mounted device, and it is assumed that the wrist unit may retrieve this downloaded information when required.

U.S. Pat. No. 5,889,737 to Alameh et al. is believed to describe a wrist mounted electronic module that may electrically link to a wrist band. The portable electronic device may thus be detached from the band when that is a more convenient mode of use. A fixed size keyboard may be incorporated into the wrist mounted electronic module. The description suggests that this keyboard is sufficiently small so that a stylus may be needed to selectively depress the keybuttons.

U.S. Pat. No. 5,881,149 to Weatherill is believed to describe that a portable electronic device may be separated into two parts which can communicate without interconnecting wires. One smaller part may be used with an incorporated earphone by holding it close to the ear, with the other part furnishing the information, as during functioning as a radiotelephone. The remaining larger part may contain the radio transceiver elements, and also a fixed-size keyboard and display.

U.S. Pat. No. 5,819,183 to Varoba et al. is believed to describe a method of increasing the acoustic efficiency of a wrist mounted telephone system by separating the microphone and earphone so as to reduce acoustic feedback. Some of this acoustic efficiency is obtained by using a wired, retractable earphone, presumably attached to the wrist unit. A fixed size keyboard is provided in the wrist unit, adjacent to a display panel. The wrist strap may contain an auxiliary battery, and a quick release clamp so that the main electronic device may be detached from its wrist mount, or worn as a pendant.

U.S. Pat. No. 5,575,576 to Roysden is believed to describe a multiple-section keyboard in which each section always remains at its original size, but may be compacted for transport by placing one section within another, i.e., stacked. This may not achieve great compaction, but when unstacked, does provide a full size keyboard, as for use in programming a wrist worn electronic device, either by linking wires, infrared or wireless arrangement.

U.S. Pat. No. 5,575,653 to Yamada et al. is believed to describe a wrist worn device such as a paging receiver in which the position of watch hands may be used to indicate chosen messages in cooperation with LED lamps which serve to inform the user about the content of messages received by the pager device.

U.S. Pat. No. 5,332,322 to Gambaro is believed to describe a version of what is referred to as a “thumb board” keyboard for use with a portable telephone (e.g., cellphone). Gambaro is believed to describe a grippable section so that all fingers except the thumb grip the thumb board device, leaving the thumb free to angulate and press buttons within an adjacent cavity. The close packed array of provided thumb-activated buttons is limited in number, so as not to require extreme thumb joint angulation. The curved base of the cavity shape puts the several thumb-buttons at easily reachable heights so as to permit easy selection by the thumb when the base and middle joints of the thumb are angulated so as to put the tip of the thumb over the chosen button among the array of buttons.

U.S. Pat. No. 4,803,487 to Willard et al. is believed to describe a multi-part communication device. A primary receiver may be worn on the body, as on a belt. When messages are received by this primary unit, this message is then sent wirelessly to a second unit, which may be a wrist carried unit. The wrist carried secondary unit may have visual display capability for direct observation of the message by the user. The received message may also be stored by the primary receiver unit.

U.S. Pat. No. 5,008,864 to Yoshitake is believed to describe a wrist worn electronic device in which the strap holding the cellphone watch is also used to hold the microphone and earphone elements. Since the strap is flexible, when a call is received, the user may remove the strap from the wrist and hold the now unfastened strap so that the microphone is near the mouth and the earphone is near the ear canal. This presumes that the microphone and the earphone are mounted on the interior of the strap, and the cellphone watch is mounted on the exterior of the wrist strap. While acoustic tubes are proposed to link the earphone or microphone, flexible wires may be used to link the elements.

U.S. Pat. No. 5,054,051 to Hoff is believed to describe a two part portable radio telephone. One portion may be an electronic wristwatch-shaped radio telephone. The watch portion which may also store selected numbers in a database. The second portion may be a compact telephone handset which had a collapsible frame for ease in carrying. The second portion may not include a dialing mechanism (such as a keyboard), and depends on the wristwatch portion to select and then utilize the chosen number for dialing input. The electronic watch portion may then wirelessly connect signals to the microphone and earphone elements in the second portion handset so that the user may have full telephonic functions available.

U.S. Pat. No. 5,224,076 to Thorp is believed to describe a wristwatch radiotelephone which is sectional. The portion that is above the wrist is large enough to contain a display and fixed size small keyboard. The connecting elements may telescope when not in use for handling radiotelephone messages so as to allow a compact carrying profile. The two ends of the display and keyboard unit are flexibly joined by a series of elements which may then jointly serve as the carrying wrist strap.

U.S. Pat. No. 5,251,189 to Thorp is believed to describe a multi-section group of rigid elements which together comprise a radiotelephone. These rigid elements are flexibly connected. This allows shaping the series of rigid elements into an arcuate band for clasping the wrist so as to carry the radiotelephone. When used for messaging, the rigid elements may then be flattened out into a substantially straight array so as to form a radiotelephone handset.

U.S. Pat. No. 5,274,613 to Seager is believed to describe a two section wristwatch-radiotelephone in which the electronic radiotelephone portion may be removed from the wrist. When removed from the wrist, the elements adjacent to the central electronic radio telephone may be reshaped into an essentially flat, elongated form for use as a radio telephone handset. This provides an efficient distancing of the microphone and earphone, so that acoustic feedback may be minimized. Thus, the carrying wrist strap always remains on the wrist, and the central radiotelephone and its adjacent elements are pulled away from the wrist strap when the wristwatch-radiotelephone portion is to be put into use.

U.S. Pat. No. 6,155,841 to Spanyar is believed to describe a two part radio telephone system in which a film keyboard is mounted on the cuff portion of the sleeve of a jacket worn by the user. This film keyboard is connected to the mobile telephone. The mobile telephone may be a separate box unit (i.e., a standard cellphone), or may be a wrist-strap carried miniature cellphone. The thin film keyboard is presented to the user as a functional section of the jacket, and this keyboard does not change size. An unusual rubber connector is described that either fits between the thumb and index finger to facilitate plugging the keyboard connector into a jack on the mobile telephone unit, or may retract into the sleeve opening so as to conceal the linking cord when not in use.

### SUMMARY

In accordance with an example embodiment of the present invention, a keyboard may be deployed from a compact planar stored shape or position to a larger planar shape for data entry use. If an elastic surface is used to control expansion (X- or Y-axes, or both), that elastic surface may include, e.g., a fabric, an elastomer, or a combination of the two, etc.

When deployed, the keybutton top surfaces move apart from each other. The fabric may be arranged as an elastomeric sheet.

According to an example embodiment of the present invention, a keyboard adapted for use in connection with an electronic device, e.g., a telephone, a cellphone, a micro cellphone, a handheld electronic device, a personal digital assistant (PDA), a palm-top computer, a smartphone, a wireless or cordless telephone, etc., includes: a fabric elastically stretchable in a substantially single plane in at least one direction between an expanded position and a contracted position; and a plurality of keycaps arranged on the fabric, each keycap corresponding to a respective key button of the electronic device, a spacing between adjacent keycaps in the at least one direction expandable and contractible in accordance with and proportional to expansion and contraction of the fabric between the expanded position of the fabric and the contracted position of the fabric. The fabric in the contracted position is arranged to be substantially entirely received in a housing of the electronic device.

Each keycap may include an indication of a corresponding numeral.

Each keycap may include an indication of at least one corresponding alphanumeric character.

The keyboard may include a frame including substantially rigid elements extendable and contractible in the at least one direction.

The substantially rigid elements may include a plurality of rigid elements configured to telescope in the at least one direction, e.g., the rigid elements may be nested one inside another.

The substantially rigid elements may include a plurality of drawer elements, which may be configured to be received in the housing of the electronic device in a storage position and which may be extendable from the housing of the electronic device into a keyboard data entry position.

The rigid elements may be substantially tubular or may have other cross-sectional shapes, e.g., square, rectangular, polygonal, etc.

The keyboard may include at least one substantially rigid panel arranged on a side of the fabric opposite the keycaps.

The keyboard may include a plurality of substantially rigid panels arranged on a side of the fabric opposite the keycaps. The panels may be configured to be stacked in the contracted position of the fabric, and the panels may be movable relative to each other in the at least one direction in accordance with expansion and contraction of the fabric between the expanded position of the fabric and the contracted position of the fabric.

The fabric may be elastically stretchable in the substantially single plane in two perpendicular directions.

The fabric may be elastically stretchable in the substantially single plane in a linear direction and an angular direction.

The keyboard may include a connection layer arranged on a side of the fabric opposite the keycaps.

The keycaps may be elastically expandable and contractible in the at least one direction in accordance with and proportional to expansion and contraction of the fabric.

The keyboard may include further features, which are more fully described below.

According to an example embodiment of the present invention, an electronic device includes a housing and a keyboard. The keyboard includes: a fabric elastically stretchable in a substantially single plane in at least one direction between an expanded position and a contracted position; and a plurality of keycaps arranged on the fabric, each keycap corresponding to a respective keybutton of the electronic device, a spacing between adjacent keycaps in the at least one direction expandable and contractible in accordance with and proportional to expansion and contraction of the fabric between the expanded position of the fabric and the contracted position of the fabric. The fabric in the contracted position is arranged to be substantially entirely received in the housing.

The keyboard of the electronic device may include any one or more of the features indicated above or those more fully described below.

The electronic device may include an ambient light sensor and a light configured to illuminate the keycaps in the expanded position of the fabric based on an ambient light level determined by the ambient light sensor.

The electronic device may be configured as a wireless telephone.

According to an example embodiment of the present invention, an electronic device includes a housing and a keyboard. The keyboard includes: a fabric elastically stretchable in a substantially single plane in at least one direction between an expanded position and a contracted position; and a plurality of keycaps arranged on the fabric, each keycap corresponding to a respective keybutton of the electronic device, a spacing between adjacent keycaps in the at least one direction expandable and contractible in accordance with and proportional to expansion and contraction of the fabric between the expanded position of the fabric and the contracted position of the fabric. The fabric in the contracted position has a width and a length in the substantially single plane not greater than a width and a length of the housing.

The keyboard of the electronic device may include any one or more of the features indicated above or those more fully described below.

As techniques for miniaturizing electronic devices allow construction of ever smaller equipment, there is still believed to be a need for providing input data to control such tiny equipment. For example, it is possible to construct a cell phone which may be carried on a wrist band, or worn much as a pendant on clothing. However, since human fingers remain unchanged in size, it may become difficult to use button input of data to such small cell phones.

An example embodiment of the present invention provides an expandable input keyboard area, so that the keyboard is stored largely “out of sight”, and is deployed out from its storage area so as to be readily usable by the cellphone user's fingers during dialing or other command function occasions

Finding the right keybutton may require a generous display space in close proximity to the numeric character to illustrate letter-number assignments. Thus, it is an aspect of an example embodiment of the present invention to provide ample display space adjacent to the provided numeric buttons so as to facilitate button selection based on required alphabetic input data when input for dialing or text-based message construction.

By supplying an enlarged keyboard size in the “ready to use” mode for a miniature device, such as a micro-cellphone, may also allow ready “finding” of the proper numeric or other control keybuttons, and allows entering data with a adult fingertip instead of a stylus device. When the keybuttons are approximately the size of an adult's fingertip, then it may also be possible to arrange and configure the keybuttons to have a comfortable travel profile during depression, and even provide a “click” as tactile feedback to the user

Users may want to detach the micro cellphone from its wrist strap “carrying” position, to facilitate easy communication use. While the micro cellphone may draw “standby” power from a battery incorporated into the wrist band, the “transmit” power may be drawn from a battery within the micro cellphone body itself. Similarly, if the micro cellphone is worn as a pendant, the user may wish to detach the micro cellphone from the pendant mount for more efficient placement between an ear and the mouth.

However, for the miniature device keyboard, it may be provided to permit expansion in a fully rectilinear mode (X and Y directions).

FIGS. 3A to 3E illustrate a combination of linear and angular expansion of the stored keyboard.

According to an example embodiment of the present invention, an increased path length between the earphone location and microphone location of the electronic device (e.g., FIGS. 2 and 3) may be provided when the keyboard is fully deployed from its storage location. The earphone stays in its position at the top of the display zone, so that it may also serve as a signaling device to notify the user that a call has been received. The user may then deploy the keyboard to begin answering the call. It may be usual to then remove the electronic device from the wrist and hold it to the side of the face, so that the earphone is close to the user's ear and the microphone is close to the user's mouth, which may improve the functioning of the acoustic components.

According to an example embodiment of the present invention, a keyboard adapted for use in connection with an electronic device includes: n elastomeric sheet stretchable in a substantially single plane in at least one linear direction and at least one angular direction between an expanded position and a contracted position; and plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the fabric and the contracted position of the fabric. The elastomeric sheet in the contracted position is arranged to be substantially entirely received in a housing of the electronic device.

Each keycap may include an indication of a corresponding numeral.

Each keycap may include an indication of at least one corresponding alphanumeric character.

The keyboard may include a frame including substantially rigid elements extendable and contractible in at least one direction.

The substantially rigid elements may include a plurality of rigid elements configured to telescope in at least one direction.

The substantially rigid elements may include a plurality of drawer elements, the drawer elements configured to be received in the housing of the electronic device in a storage position and extendable from the housing of the electronic device into a keyboard data entry position.

The rigid elements may be substantially tubular.

The keyboard may include at least one substantially rigid panel arranged on a side of the elastomeric sheet opposite the keycaps.

The keyboard may include a plurality of substantially rigid panels arranged on a side of the elastomeric sheet opposite the keycaps, the panels configured to be stacked in the contracted position of the elastomeric sheet, the panels may be movable relative to each other in at least one direction in accordance with expansion and contraction of the elastomeric sheet between the expanded position of the elastomeric sheet and the contracted position of the elastomeric sheet.

The elastomeric sheet may be elastically stretchable in the substantially single plane in one linear direction and one angular direction about an axis perpendicular to the one linear direction.

The keyboard may include a connection layer arranged on a side of the elastomeric sheet opposite the keycaps.

The keycaps may be elastically expandable and contractible in the at least one direction in accordance with and proportional to expansion and contraction of the elastomeric sheet.

According to an example embodiment of the present invention, an electronic device includes: a housing; and a keyboard. The keyboard includes: an elastomeric sheet elastically stretchable in a substantially single plane in at least one linear direction and at least one angular direction between an expanded position and a contracted position; and a plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the elastomeric sheet and the contracted position of the elastomeric sheet. The elastomeric sheet in the contracted position is arranged to be substantially entirely received in the housing.

The elastomeric sheet may be elastically stretchable in the substantially single plane in one linear direction and one angular direction about an axis perpendicular to the one linear direction.

The electronic device may include an ambient light sensor and a light configured to illuminate the keycaps in the expanded position of the elastomeric sheet based on an ambient light level determined by the ambient light sensor.

Each keycap may include an indication of a corresponding numeral.

Each keycap may include an indication of at least one corresponding alphanumeric character.

The electronic device may include a frame including substantially rigid elements extendable and contractible in at least one direction.

The substantially rigid elements may include a plurality of rigid elements configured to telescope in at least one direction.

The substantially rigid elements may include a plurality of drawer elements, and the drawer elements may be configured to be received in the housing in a storage position and extendable from the housing into a keyboard entry position.

The rigid elements may be substantially tubular.

The electronic device may include at least one substantially rigid panel arranged on a side of the elastomeric sheet opposite the keycaps.

The electronic device may include a plurality of substantially rigid panels arranged on a side of the elastomeric sheet opposite the keycaps, and the panels may be configured to be stacked in the contracted position of the elastomeric sheet, the panels movable relative to each other in at least one direction in accordance with expansion and contraction of the elastomeric sheet between the expanded position of the elastomeric sheet and the contracted position of the elastomeric sheet.

The electronic device may include a connection layer arranged on a side of the elastomeric sheet opposite the keycaps.

The electronic device may be configured as a wireless telephone.

The keycaps may be elastically expandable and contractible in the at least one linear direction and the at least one angular direction in accordance with and proportional to expansion and contraction of the elastomeric sheet.

According to an example embodiment of the present invention, an electronic device includes: a housing; and a keyboard. The keyboard includes: an elastomeric sheet elastically stretchable in a substantially single plane in at least one linear direction and at least one angular direction between an expanded position and a contracted position; and a plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the elastomeric sheet and the contracted position of the elastomeric sheet. The elastomeric sheet in the contracted position has a width and a length in the substantially single plane not greater than a width and a length of the housing.

Further features and aspects of example embodiments of the present invention are described below and illustrated in the appended Figures.

### BRIEF DESCRIPTION OF THE DRAWINGS

FIGS. 1A, 1B, 1C and 1D are front views of micro cellphone keybutton tops or keycaps.

FIGS. 2A and 2B are closed and open views, respectively, of a micro cellphone keyboard which may entirely disappear from view during storage or transport.

FIGS. 3A, 3B, 3C and 3D illustrate a two drawer structure for housing a micro cellphone keyboard so that it may disappear from view during storage or transport.

FIG. 4 illustrates a micro cellphone “main box” for display and electronics and an associated keyboard frame.

FIG. 5 is a detailed view of a telescoping keyboard frame arranged to support a micro cellphone keyboard.

FIG. 6 illustrates frame and support panels for a micro cellphone keyboard during storage and progressive opening.

FIGS. 7A, 7B and 7C illustrate a planar micro cellphone in which a keyboard thereof is always visible but may stretch out for communication use.

FIGS. 8A and 8B illustrates the assignment of alphabetic letters to numbers on a miniature cellphone keyboard.

FIG. 8C illustrates a miniature cellphone worn atop a wrist band.

FIG. 8D illustrates a miniature cellphone worn as a pendant.

FIGS. 9A to 9D illustrates a rectilinear expansion of a stored keyboard out from under the miniature cellphone and FIG. 9E illustrates the actual keyboard after X and Y expansion.

FIGS. 10A to 10D illustrate linear and angular expansion of a stored keyboard when it is deployed out from under a miniature cellphone, and FIG. 10E illustrates the actual keyboard after the Y and β expansion.

### DETAILED DESCRIPTION

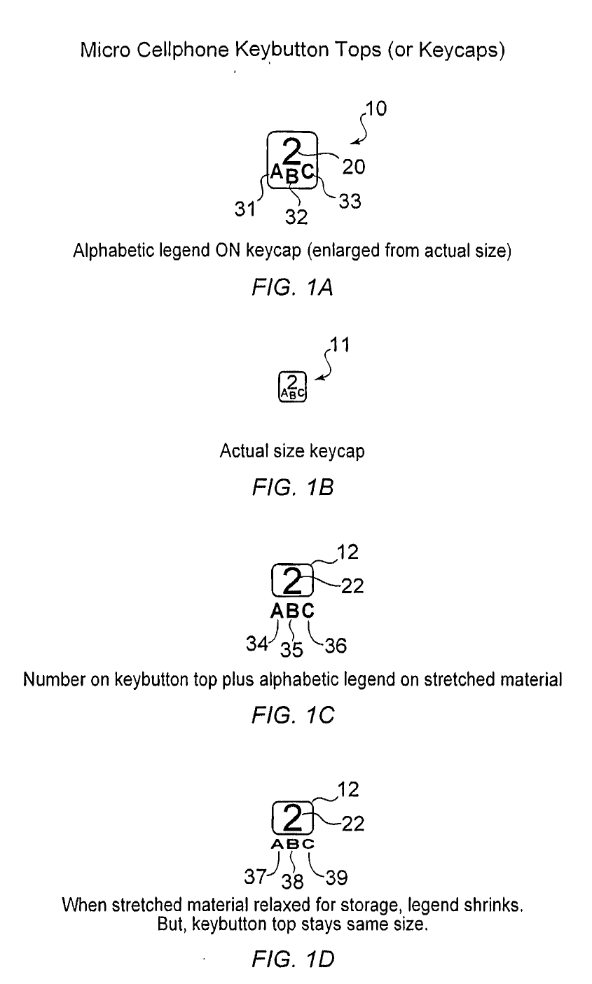

Referring to FIGS. 1A, 1B, 1C and 1D, micro cellphone dialing keybutton tops or keycaps are illustrated. In FIG. 1A, 10 represents the keycap, with numeric legend 20 inscribed on it, here the legend being the numeral 2. Also inscribed on the keycap 10 are the alphabetic legends 31, 32, and 33 (e.g., “A,” “B,” and “C,” respectively). It should be understood that any number of alphanumeric legends may be inscribed.

In FIG. 1B, the keycap is illustrated approximately actual size as keycap 11.

In FIG. 1C, only the numeric legend 22 is inscribed on keycap 12, and alphabetic legends 34, 35, and 36 are inscribed on stretched material which surrounds the keycap 12.

In FIG. 1D, the stretched material is vertically relaxed for storage, so the alphabetic legends 37, 38, and 39 shrink in vertical size. Note that the inscribed numeric legend 22 remains the same size as in FIG. 1C.

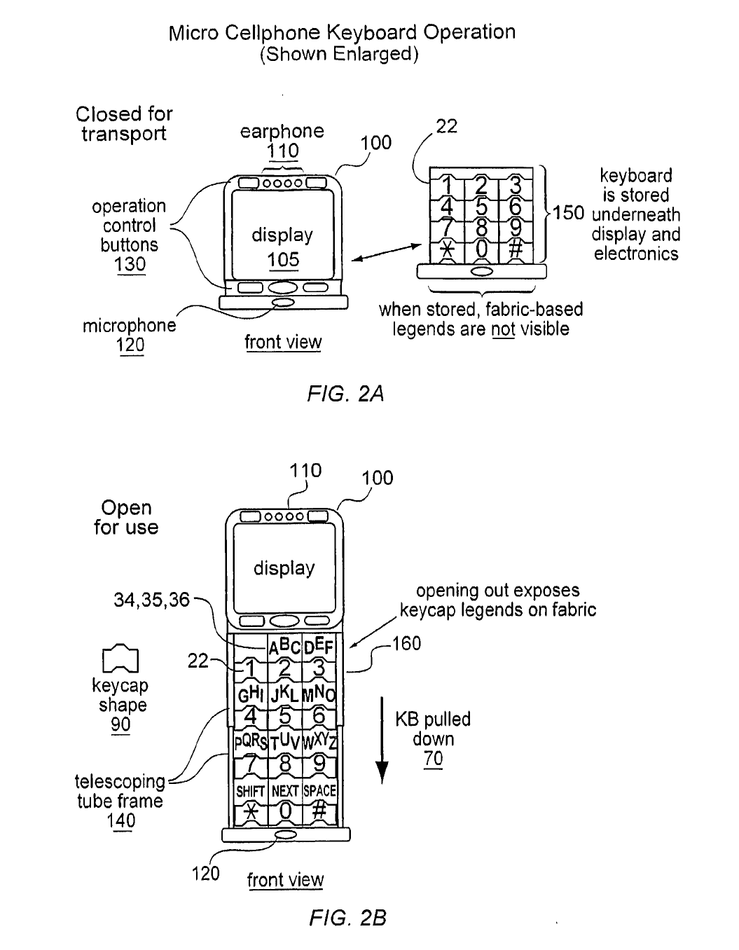

Referring to FIGS. 2A and 2B, keyboard operation of a micro cellphone is illustrated.

In FIG. 2A, the keyboard is closed for storage or transport. The most prominent device feature remaining is the case 100 and display 105 in its center. At the top of the case 100, the aperture containing the earphone 110 is visible. The bottom of case 100, the aperture containing the microphone 120 is visible. The operational controls (e.g., buttons) 130 are illustrated at the periphery of the case 100. The keyboard 150 is not visible, since it is stored underneath the case 100. If the device were taken apart, only the numeric legends 22 would be visible on the stored keyboard 150, since the alphabetic legends (e.g., 34, 35, 36 in FIG. 2B) are hidden by the keycaps 90 (see FIG. 2B).

In FIG. 2B, the micro cellphone is opened for use, e.g., by pulling the telescoping tube frame downwardly. The keyboard 160 is completely extended downwardly, and the alphabetic legends 34, 35, 46 appear just atop the keybuttons 90 which have the numeric legends 22 inscribed thereon.

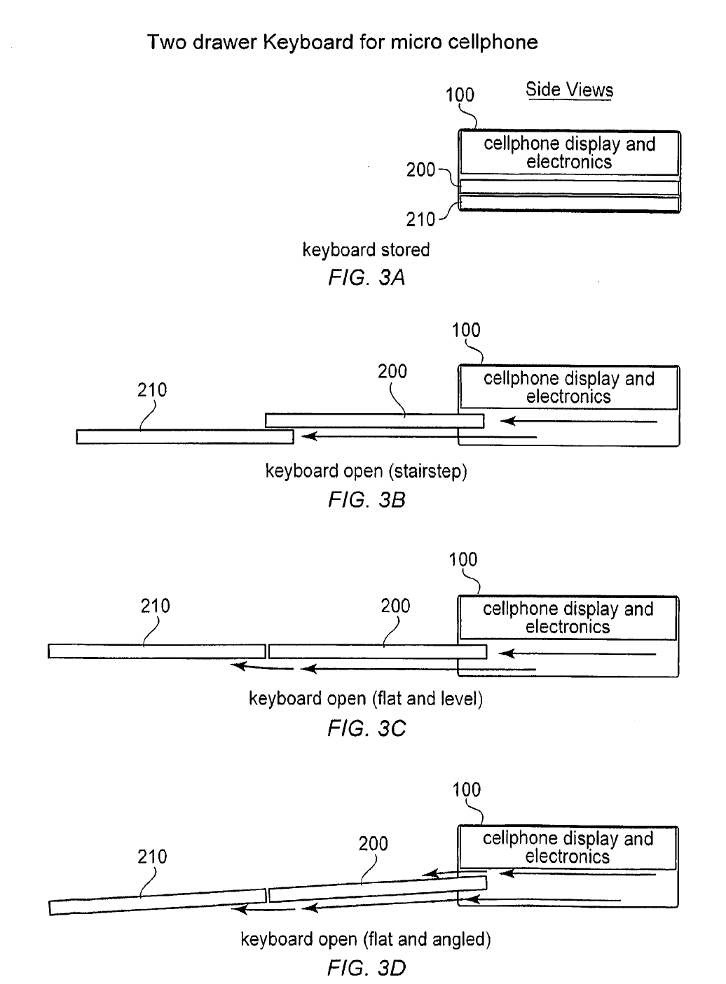

Referring to FIGS. 3A, 3B, 3C and 3D, a two drawer structure for a micro cellphone keyboard is illustrated.

In FIG. 3A, the two keyboard drawers 200 (upper) and 210 (lower) are stored within the base of case 100. In FIG. 3B, both drawer 200 and 210 are fully extended, and present a “stair step” configuration as illustrated. In FIG. 3C, both drawers 200 and 210 are again fully extended, but the support harness positions drawer 210 at the same level as drawer 200, so as to form a flat surface, level with the bottom surface of the case 100.

In FIG. 3D, the drawers 200 and 210 are again fully extended outwardly from the case 100, but are arranged to form a flat surface angled with respect to the bottom of cellphone case 100. This angular positioning may be desirable if the micro cellphone is worn on the wrist while dialing phone numbers, rather than being detached from the wrist.

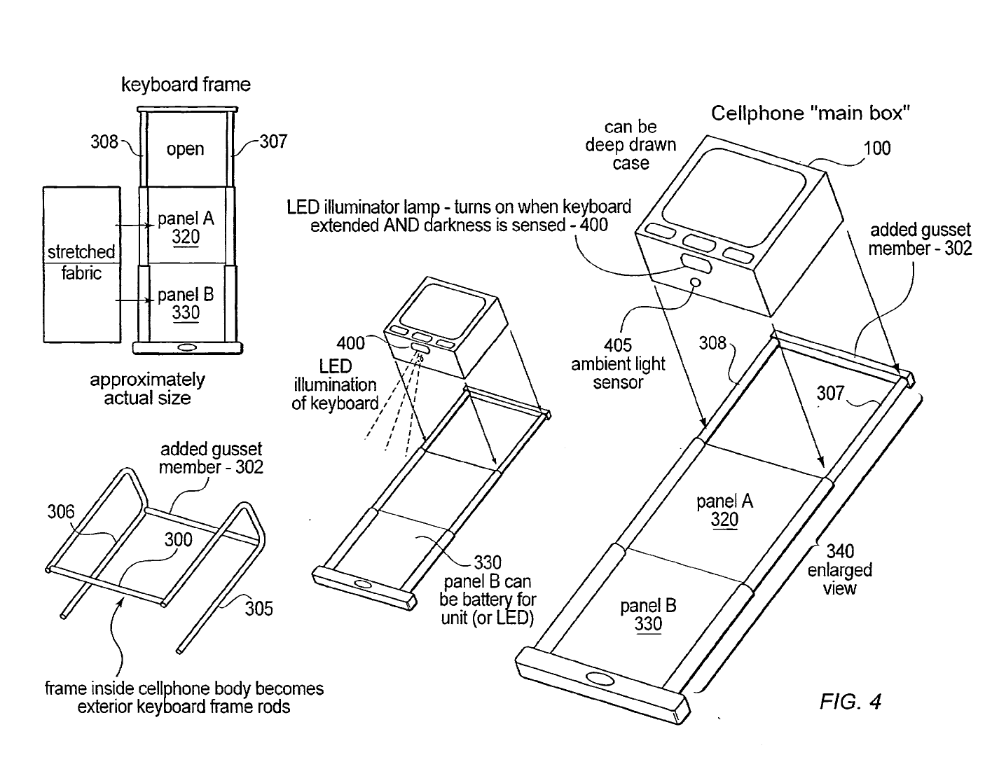

Referring to FIG. 4, the micro cellphone “main box” case 100 is illustrated. The bent frame 300 is arranged to support the base 100, and the frame 300 has side legs 305 and 306. Added gusset member 302 is placed at the ends of bent frame 300, arranged as a cross support between legs 305 and 306. Note that leg 305 joins to telescoping tube 307 of sliding panel frame 340, and leg 306 joins to telescoping tube 308. Sliding panel A is 320 and sliding panel B is 330 and include cooperating parts of sliding panel frame 340.

At the upper right, note that an illumination LED 400 is provided on the side of the case 100 that faces the sliding panel frame 340. Just below LED 400 is ambient light sensor 405, which is connected to a power circuit when the keyboard 160 is extended fully outwardly. If the ambient light level is low, the sensor 405 operates to apply power to the LED 400, so that the keyboard surface 320 and 330 are illuminated for user convenience.

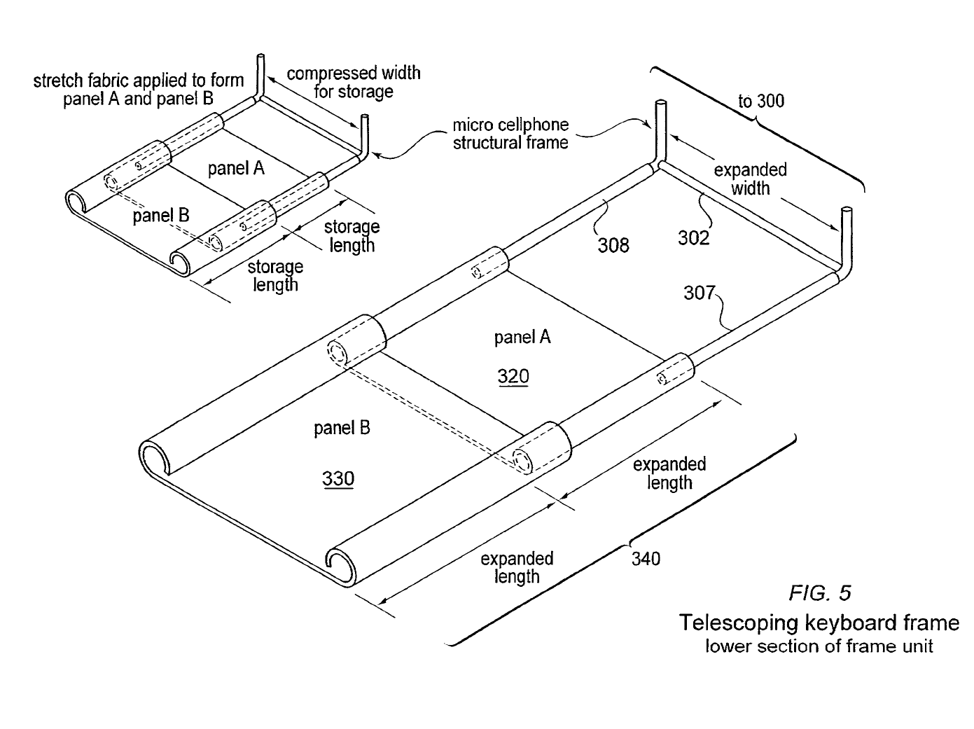

Referring to FIG. 5, a more detailed view of the telescoping tube frame is provided. At upper left, the frame is nearly closed for storage within the micro cellphone body (case 100). At lower right, the panel A 320 and panel B 330 are slid outwardly to form the extended keyboard base 340.

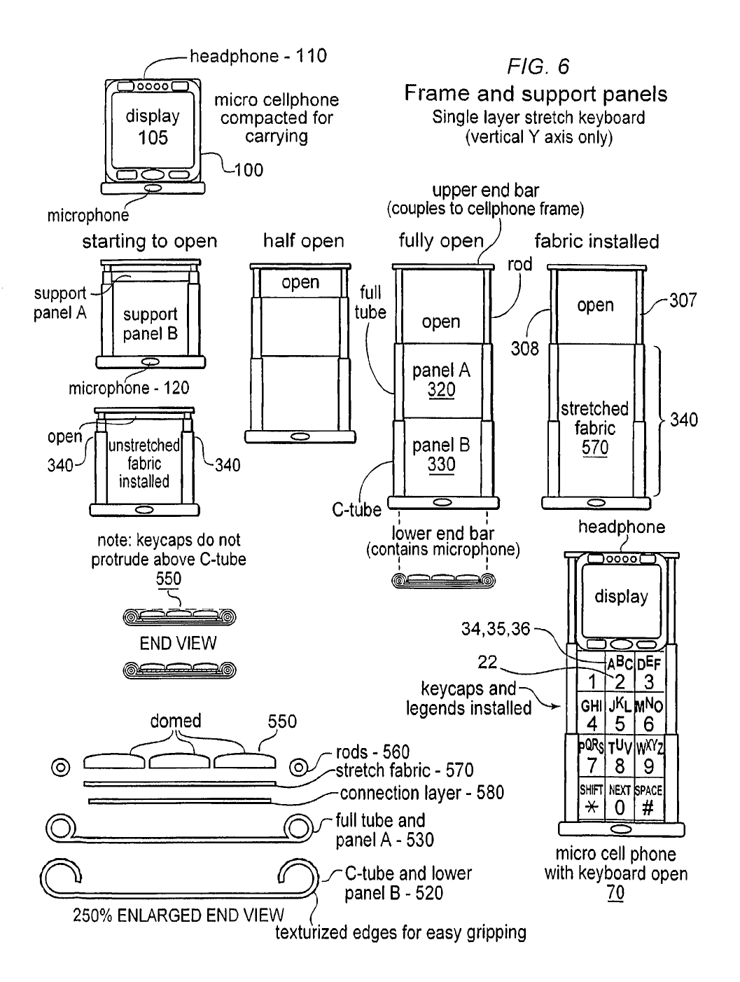

Referring to FIG. 6, at upper left, the keyboard 70 is illustrated as having been stored wholly within case 100 of the micro cellphone. The first drawing below the upper left illustrates a construction of the telescoping tubes 340 in compressed position. Just below that view is another view illustrating the attachment of an unstretched fabric on the compressed frame formed by telescoping tubes 340.

Immediately to the right is a “half open” illustration of the telescoping tubes as they are being extended, and then another illustration at the right illustrating the fully exposed panel A 320 and the panel B 330.

To the far right of FIG. 6 is an illustration showing the fabric 570 which is stretched by the full extension of telescoping tubes 340.

At lower right of FIG. 6 is an illustration showing the fully extended keyboard 70, complete with the alphanumeric legends 22 and alphabetic legends 34, 35 and 36 inscribed to aid the user in dialing the micro cellphone.

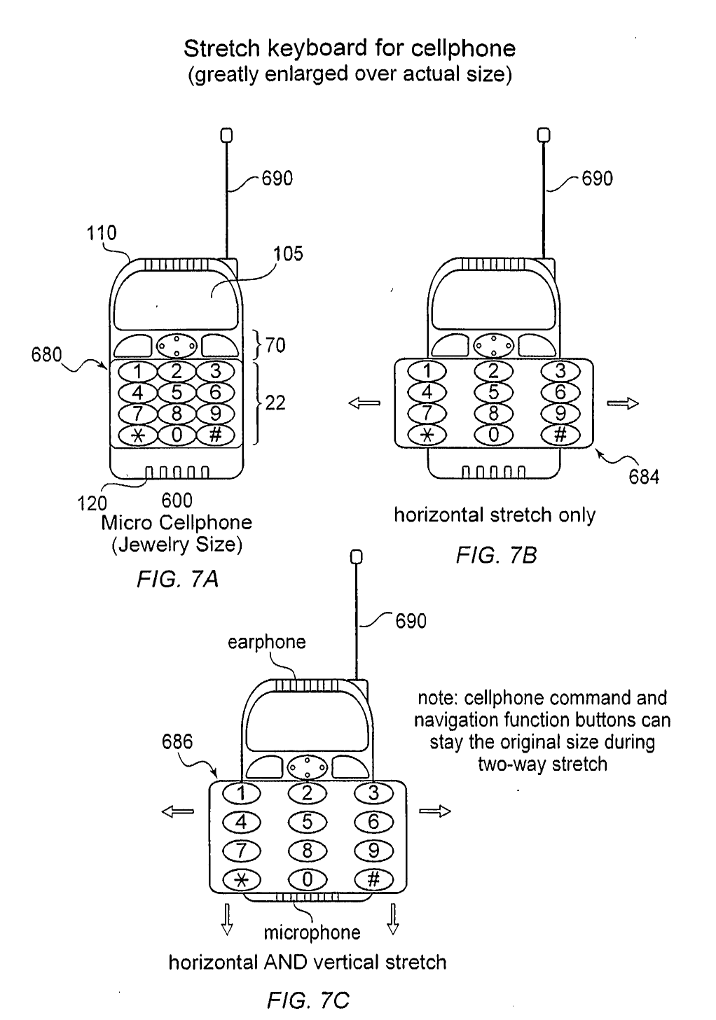

FIGS. 7A, 7B and 7C illustrate a stretch keyboard for use on a micro cellphone, but in a manner that keeps the keyboard surface 80 always visible.

In FIG. 7A, note that only numeric legends 22 are illustrated on keyboard surface 80 for clarity. Note also that antenna 90 is shown extended and that for many high frequency micro cellphones, such a protruding wire antenna 90 may not be necessary (only a stub antenna may be provided). Earphone openings 110 are illustrated at the top of the micro cellphone 600, and microphone openings 120 at the bottom of micro cellphone 600. The display surface 105 is located at the top end of the cellphone 600, and the operational controls are located just below the display surface 105.

In FIG. 7B, the keyboard surface 680 is illustrated as having been stretched out horizontally to form laterally stretched keyboard surface 684. Since the keybuttons do not expand, this creates space between the keycap columns so that the keycaps are easier to push and mistaken button pushing (or confusion) may be markedly less likely.

In FIG. 7C, the keyboard surface 680 is illustrated as having been stretched out horizontally and vertically to form entirely stretched keyboard surface 686. This added vertical stretching may allow for increased room between the key rows, which may further reduce mistake in button pushing and may increase operator convenience. Since the operator controls may be used less frequently than the numeric keycaps, the operator controls remain the same size and spacing when the keyboard surface 680 expands (as to laterally increased size 684 or fully expanded surface 686).

An example embodiment of the present invention may provide an expandable input keyboard area, so that the keyboard is stored largely “out of sight”, and is deployed out from its storage area so as to be readily usable by the cellphone user's fingers during dialing or other command function occasions (as to change the audible volume of a miniature speaker, the visual appearance of the display, or just to discontinue the call). The deployment of the keyboard to a significantly enlarged mode allows the user to readily find the needed keybutton, and to then press it to enter the proper command.

Note that finding the right keybutton may often require a generous display space in close proximity to the numeric character to illustrate letter-number assignments. An example is shown in FIG. 1, which provides the inscribed letters “A, B, and C” near to the numeric “two” atop the middle button, and the letters “D, E, and F” near the numeric “three” atop the leftmost button (note that this layout will vary depending on the system design).

When the whole cellphone is the size of a wrist watch or pendant, providing a “stylus size” keybutton with adjacent miniature letters (as in FIG. 1B) may be of little help to users with reduced vision abilities. Thus, an example embodiment of the present invention may provide ample display space adjacent to the provided numeric buttons so as to facilitate button selection based on required alphabetic input data when input for dialing or text-based message construction. An example would be when it is desired to dial “1-212-Call Sam” as a link to a local plumber, wherein the cellphone user has to transliterate the letters of “Call Sam” into the number sequence 225-5726 (as in FIG. 1A). If the alphabetic symbols placed near the numeric button labels are sufficiently large, the task is readily accomplished. Thus, the provision of adequate “display space” for a miniature device keyboard may be important to provide easy data input.

Note also that by supplying an enlarged keyboard size in the “ready to use” mode for a miniature device, such as a micro-cellphone, may also allow ready “finding” of the proper numeric or other control keybuttons, and may allow entering data with a adult fingertip instead of a stylus device. When the keybuttons are approximately the size of an adult's fingertip, then it is also possible to arrange and configure the keybuttons to have a comfortable travel profile during depression, and even provide a “click” as tactile feedback to the user that the keybutton has been successfully depressed and electronic circuit actuation has taken place.

Users may want to detach the micro cellphone from its wrist strap “carrying” position, to facilitate easy communication use. While a micro cellphone may draw “standby” power from a battery incorporated into the wrist band, the “transmit” power may be drawn from a battery within the micro cellphone body itself. Similarly, if the micro cellphone is worn as a pendant, the user may wish to detach the micro cellphone from the pendant mount for more efficient placement between an ear and the mouth.

Provision of a keyboard which expands out from a smaller stored shape for use may be provided by using a stretchable base media, such as woven threads or an elastomeric substrate. Such provision for a full size keyboard using elastic belts is described in U.S. Pat. No. 6,739,774 to Lahr, which is expressly incorporated herein in its entirety by reference thereto. The substrate media may be expanded only in a lateral direction, i.e., “isolinear” or “x-only expansion.”

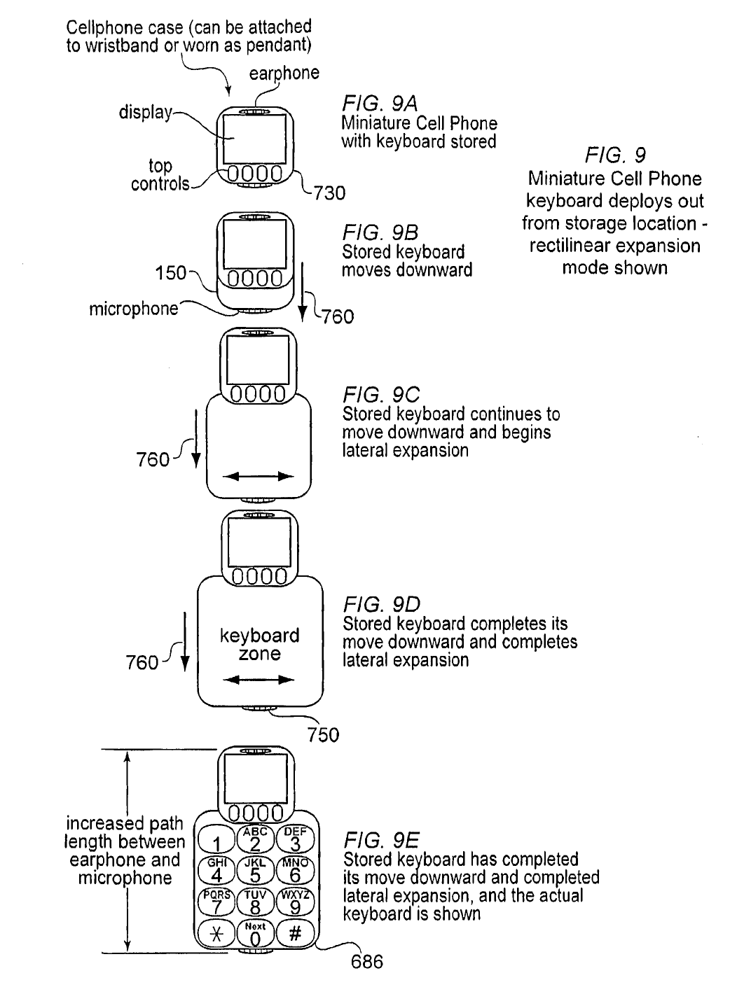

However, for a miniature device keyboard, it may be favorable to provide the expansion in a fully rectilinear mode (X and Y directions), as illustrated in FIG. 9. Alternately, a circular expansion may be used (expansion angle β) or a combination of angular and linear expansion (Y plus β) FIGS. 2A to 2E illustrate rectilinear expansion of the stored keyboard. In the bottom FIG. 2E, the actual keybuttons are illustrated atop the expanded keyboard.

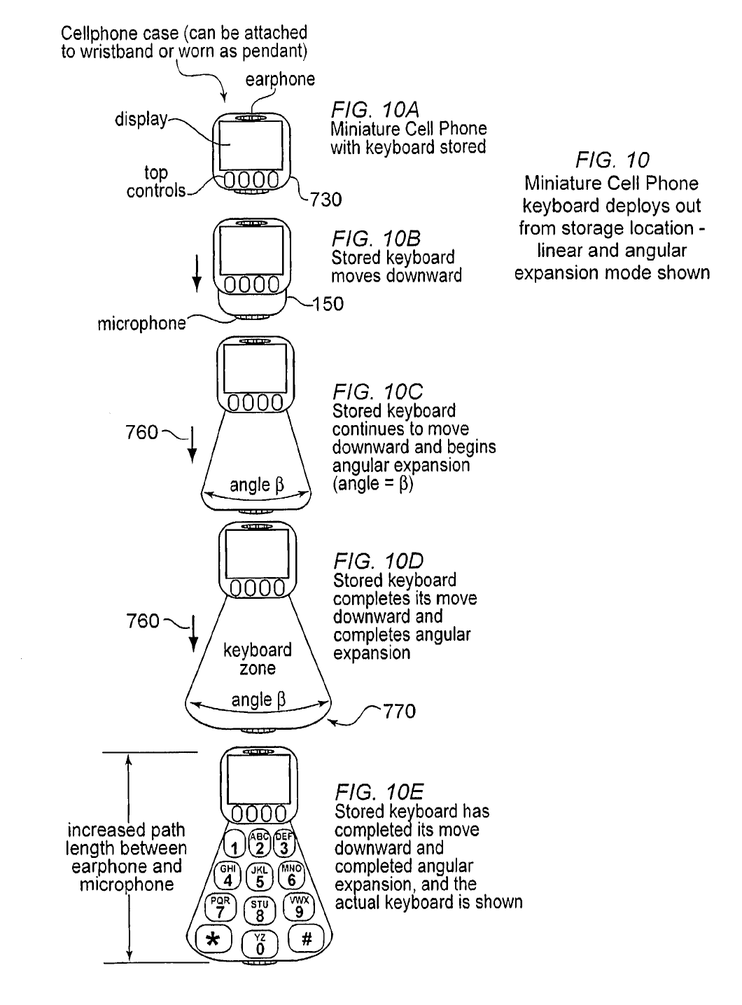

FIG. 10 illustrates a combination of linear and angular expansion of the stored keyboard. Here the stored keyboard begins to expand angularly soon after emerging from the storage location. In the bottom FIG. 10E, the actual keybuttons are illustrated atop the completely expanded keyboard. The actual angle β used is a design detail, as is the particular combination of linear and angular expansion chosen.

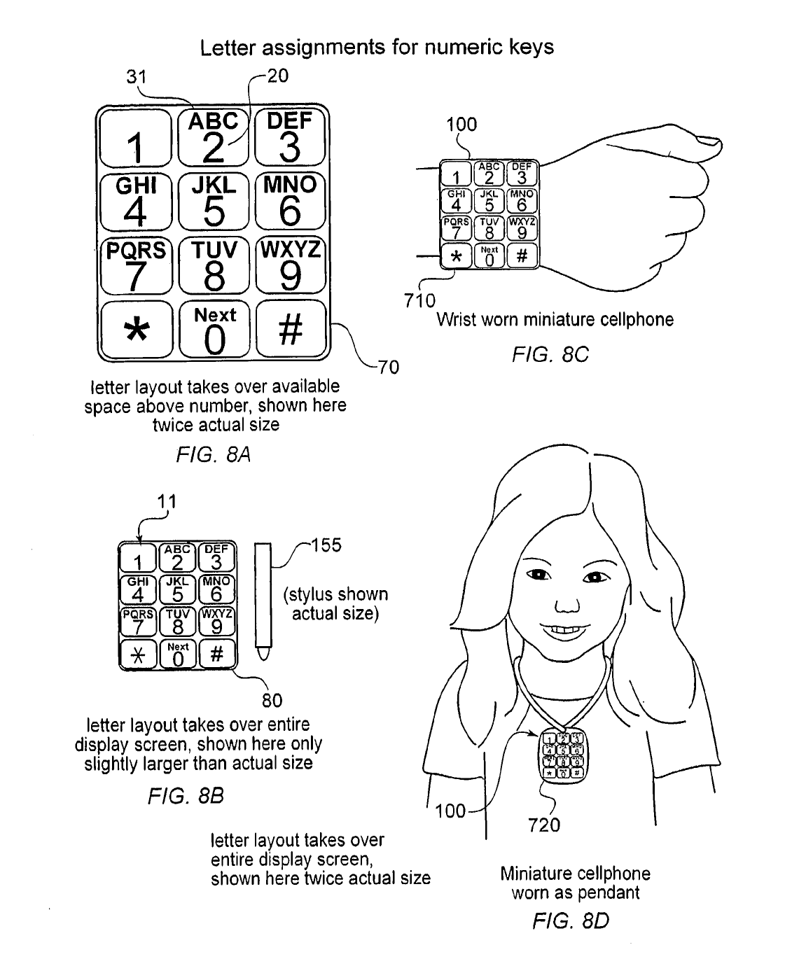

In FIG. 8A, an expanded keyboard 70 for use with a very small cellphone or other similar electronic device is illustrated. The transliteration between alphabetic symbols and numeric keys is designated, as for instance, letter “A” 31 is enscribed adjacent to the number “2” 20. Note that this “assignment table” is arbitrary, and various equipment designers have chosen individual assignment tables for their products.

In FIG. 8B, an unexpanded keyboard 80 is illustrated, together with a stylus 155 which is used to operate the tiny keys 11 on the unexpanded keyboard 80.

As illustrated in FIG. 8C, the miniature cellphone 100 is detachably worn on a wrist strap so as to become a wrist cellphone 710.

As illustrated in FIG. 8D, the miniature cellphone 100 is worn as a pendant 720. The mounting to a neckstrap or clothing clasp may be detachable for facilitating use as a communication device when making or answering a telephone call.

In FIG. 9A, a miniature cell phone 730 is illustrated. The keyboard is stored underneath the case 80 and is not visible.

As illustrated in FIGS. 9B to 9E, the stored keyboard 150 moves downward (minus Y direction) relative to the case of the cellphone 730. During downward movement, the stored keyboard expands, first in a vertical direction, then in a horizontal direction.

As illustrated in FIG. 9E, the stored keyboard 150 is expanded to full use size 686, and a typical keyboard layout of numeric keys as 20, and adjacent alphabetic labels as 31 is applied to the keybutton area.

In FIG. 10A, a miniature cellphone 730 with keyboard 150 stored underneath the case (and thus not visible) is illustrated.

As illustrated in FIGS. 10B to 10E, the stored keyboard moves out from under the cellphone 730. The first movement as illustrated in FIG. 10B is vertical (minus Y direction 760).

As illustrated in FIG. 10C, the stored keyboard 150 continues to expand downward, and begins angular expansion (angle=β 770).

As illustrated in FIG. 10D, the stored keyboard 150 completes its downward movement (minus Y direction 760) and completes its angular expansion β 770.

As illustrated in FIG. 10E, the stored keyboard 150 is expanded to full use size 686, and a typical keyboard layout of numeric keys such as 20, and adjacent alphabetic labels such as 31 is applied to the keybutton area.

It should be appreciated that a keyboard according to an example embodiment of the present invention may be, e.g., mildly arcuate in the “ready for use” position and may have a very small arcuate curve in the stored position, with, e.g., the bottom of the micro cellphone having a cooperating shape and geometry. The pitch for such an arcuate form may have, e.g., no more than a 25% center height compared to the width of the keyboard at 100% expansion, e.g., a 10% center height as compared to the width of the keyboard at 100% expansion, etc. That is, a keyboard according to an example embodiment of the present invention may not be perfectly planar and may have an arcuate form in a continuous, non-folded surface. As an example, the geometry of such a keyboard may have a center height that may be, e.g., 10% to 25%, out of a plane between the two lateral ends of the keyboard at 100% expansion. In addition, a keyboard according to an example embodiment of the present invention may be configured for spherical or oblate expansion.

### REFERENCE CHARACTERS USED

10 keybutton cap (enlarged view)
11 keybutton cap (actual size)
12 keybutton cap mounted on stretchable material
20 numeric keycap legend (enlarged view)
22 numeric keycap legend on solid keycap
31 alphabetic legend, here “A” (enlarged view)
32 alphabetic legend, here “B” (enlarged view)
33 alphabetic legend, here “C” (enlarged view)
34 alphabetic legend, here “A” (inscribed on stretched material)
35 alphabetic legend, here “B” (inscribed on stretched material)
36 alphabetic legend, here “C” (inscribed on stretched material)
37 alphabetic legend, here “A” (inscribed on stretched material, now relaxed)
38 alphabetic legend, here “B” (inscribed on stretched material, now relaxed)
39 alphabetic legend, here “C” (inscribed on stretched material, now relaxed)
70 keyboard, pulled down from storage
90 keycap shape
100 micro cellphone case
105 micro cellphone display
110 micro cellphone earphone
120 micro cellphone microphone
130 micro cellphone operational controls
140 telescoping tube frame
150 micro cellphone keyboard as stored (reduced dimensions)
160 telescoping tube frame extended (keyboard “open”)
200 keyboard drawer (upper)
210 keyboard drawer (lower)
300 micro cellphone body frame
302 body frame gusset bar
305 body frame horizontal bar (right side)
306 body frame horizontal bar (left side)
307 telescoping tube frame right side end (joins to 305)
308 telescoping tube frame left side end (joins to 306)
320 Panel A of keyboard structure (portion of drawer 200)
330 Panel B of keyboard structure (portion of drawer 210)
340 extended telescoping frame structure
400 LED illuminator lamp
405 ambient light sensor
520 rolled tube edge and Panel B structure
530 C-tube edge and Panel A structure
550 domed keybuttons (gives tactile feel upon depression)
560 support rod portion of telescoping structure 340
570 stretched material (as fabric)
600 micro cellphone with keyboard that is always visible
680 micro cellphone with keyboard in compacted size
684 micro cellphone with keyboard in horizontally stretched size
686 micro cellphone with keyboard in horizontally and vertically stretched size
690 antenna for micro cellphone
80 Micro keyboard, unexpanded
155 Stylus for operating micro sized keybuttons
610 Micro cellphone with keyboard that is stored under cellphone body
700 Numeric keyboard with alphabetic characters assigned to specific number keys
710 Micro cellphone worn atop a wrist strap (optionally detachable)
720 Micro cellphone worn as a pendant, optionally with detachable mounting
730 Micro cellphone body (can be on wrist, as pendant, or pocketed)
750 Expansion of micro cellphone keyboard laterally (“X” direction)
760 Expansion of micro cellphone keyboard vertically (“Y” direction)
770 Expansion of micro cellphone keyboard angularly (β increases)

What is claimed is:

1. A keyboard adapted for use in connection with an electronic device, comprising:
an elastomeric sheet stretchable in a substantially single plane in at least one linear direction and at least one angular direction between an expanded position and a contracted position; and
a plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the fabric and the contracted position of the fabric;
wherein the elastomeric sheet in the contracted position is arranged to be substantially entirely received in a housing of the electronic device.

2. The keyboard according to claim 1, wherein each keycap includes an indication of a corresponding numeral.

3. The keyboard according to claim 1, wherein each keycap includes an indication of at least one corresponding alphanumeric character.

4. The keyboard according to claim 1, further comprising a frame including substantially rigid elements extendable and contractible in at least one direction.

5. The keyboard according to claim 4, wherein the substantially rigid elements include a plurality of rigid elements configured to telescope in at least one direction.

6. The keyboard according to claim 4, wherein the substantially rigid elements include a plurality of drawer elements, the drawer elements configured to be received in the housing of the electronic device in a storage position and extendable from the housing of the electronic device into a keyboard data entry position.

7. The keyboard according to claim 5, wherein the rigid elements are substantially tubular.

8. The keyboard according to claim 1, further comprising at least one substantially rigid panel arranged on a side of the elastomeric sheet opposite the keycaps.

9. The keyboard according to claim 1, further comprising a plurality of substantially rigid panels arranged on a side of the elastomeric sheet opposite the keycaps, the panels configured to be stacked in the contracted position of the elastomeric sheet, the panels movable relative to each other in at least one direction in accordance with expansion and contraction of the elastomeric sheet between the expanded position of the elastomeric sheet and the contracted position of the elastomeric sheet.

10. The keyboard according to claim 1, wherein the elastomeric sheet is elastically stretchable in the substantially single plane in one linear direction and one angular direction about an axis perpendicular to the one linear direction.

11. The keyboard according to claim 1, further comprising a connection layer arranged on a side of the elastomeric sheet opposite the keycaps.

12. The keyboard according to claim 1, wherein the keycaps are elastically expandable and contractible in the at least one direction in accordance with and proportional to expansion and contraction of the elastomeric sheet.

13. An electronic device, comprising:
a housing; and
a keyboard including:
an elastomeric sheet elastically stretchable in a substantially single plane in at least one linear direction and at least one angular direction between an expanded position and a contracted position; and
a plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the elastomeric sheet and the contracted position of the elastomeric sheet;
wherein the elastomeric sheet in the contracted position is arranged to be substantially entirely received in the housing.

14. The electronic device according to claim 13, wherein the elastomeric sheet is elastically stretchable in the substantially single plane in one linear direction and one angular direction about an axis perpendicular to the one linear direction.

15. The electronic device according to claim 13, further comprising an ambient light sensor and a light configured to illuminate the keycaps in the expanded position of the elastomeric sheet based on an ambient light level determined by the ambient light sensor.

16. The electronic device according to claim 13, wherein each keycap includes an indication of a corresponding numeral.

17. The electronic device according to claim 13, wherein each keycap includes an indication of at least one corresponding alphanumeric character.

18. The electronic device according to claim 13, further comprising a frame including substantially rigid elements extendable and contractible in at least one direction.

19. The electronic device according to claim 18, wherein the substantially rigid elements include a plurality of rigid elements configured to telescope in at least one direction.

20. The electronic device according to claim 18, wherein the substantially rigid elements include a plurality of drawer elements, the drawer elements configured to be received in the housing in a storage position and extendable from the housing into a keyboard entry position.

21. The electronic device according to claim 19, wherein the rigid elements are substantially tubular.

22. The electronic device according to claim 13, further comprising at least one substantially rigid panel arranged on a side of the elastomeric sheet opposite the keycaps.

23. The electronic device according to claim 13, further comprising a plurality of substantially rigid panels arranged on a side of the elastomeric sheet opposite the keycaps, the panels configured to be stacked in the contracted position of the elastomeric sheet, the panels movable relative to each other in at least one direction in accordance with expansion and contraction of the elastomeric sheet between the expanded position of the elastomeric sheet and the contracted position of the elastomeric sheet.

24. The electronic device according to claim 13, further comprising a connection layer arranged on a side of the elastomeric sheet opposite the keycaps.

25. The electronic device according to claim 13, wherein the electronic device is configured as a wireless telephone.

26. The electronic device according to claim 13, wherein the keycaps are elastically expandable and contractible in the at least one linear direction and the at least one angular direction in accordance with and proportional to expansion and contraction of the elastomeric sheet.

27. An electronic device, comprising:
a housing; and
a keyboard including:
an elastomeric sheet elastically stretchable in a substantially single plane in at least one linear direction and at least one angular direction between an expanded position and a contracted position; and
a plurality of keycaps arranged on the elastomeric sheet, each keycap corresponding to a respective key of the electronic device, a spacing between adjacent keycaps in the at least one linear direction and the at least one angular direction expandable and contractible in accordance with and proportional to expansion and contraction of the elastomeric sheet between the expanded position of the elastomeric sheet and the contracted position of the elastomeric sheet;
wherein the elastomeric sheet in the contracted position has a width and a length in the substantially single plane not greater than a width and a length of the housing.
